(19) United States
(12) Patent Application Publication
(10) Pub. No.: US 2012/0075217 A1
(43) Pub. Date: Mar. 29, 2012

(54) OBJECT SENSING DEVICE

(76) Inventors: Yun-Cheng Liu, Taipei City (TW); Chung-Sheng Wu, New Taipei City (TW)

(21) Appl. No.: 13/235,531

(22) Filed: Sep. 19, 2011

(30) Foreign Application Priority Data
Sep. 24, 2010 (TW) 099132336

(51) Int. Cl. G06F 3/041; G09G 5/00

(52) U.S. Cl. 345/173; 345/156

(57) ABSTRACT

An object sensing device includes a display panel, a first image sensing unit, a vibration sensing unit and a control unit. The first image sensing unit is disposed at a periphery of the display panel. The first image sensing unit has a first sensing area related to the display panel. The vibration sensing unit is disposed at the periphery of the display panel. The control unit is electrically connected to the display panel, the first image sensing unit and the vibration sensing unit. When the first image sensing unit senses an object in the first sensing area and the vibration sensing unit senses a vibration acted by the object on the display panel, the control unit controls the display panel to execute a predetermined function.

### BACKGROUND OF THE INVENTION

1. Field of the Invention

The present invention relates to an object sensing device, and more specifically, to an object sensing device having a vibration sensing function.

2. Description of the Prior Art

Since consumer electronic products have become more and more lighter, thinner, shorter, and smaller, there is no space on these products for containing a conventional input device, such as a mouse, a keyboard, a stylus, etc. With development of touch technology, in various kinds of consumer electronic products (e.g. a display device, an all-in-one machine, a mobile phone, or a personal digital assistant (PDA)), a touch device has become a main tool for data input. Furthermore, as touch technology advances, an electronic device with a large size and a multi-touch function will be widely used in daily life. Compared with other touch design, such as a resistive touch design, a capacitive touch design, an ultrasonic touch design, or a projective touch design, an optical touch design has lower cost and is easier to use.

In general, a conventional optical touch design is to sense a touch position of an object (e.g. a user's finger or a stylus) on a touch screen in an optical sensing manner. That is to say, when an image sensing unit on an optical touch device senses an object in a sensing area, the optical touch device can calculate the touch position of the object accordingly. However, since the optical touch device only utilizes the image sensing unit to sense the object in the sensing area, misjudgment may occur in optical touch positioning. For example, when a user has not decided which function to execute yet so as to move the object forth and back in the sensing area, the image sensing unit has already sensed the object in the sensing area. As a result, the optical touch device may possibly mistake the function that the user wants to execute for another function. Furthermore, if the user just utilizes the object to lightly touch the touch screen twice in the sensing area for executing a double-click function, the optical touch device may possibly misjudge that the user wants to execute a one-click function. The said misjudgment problems may cause the user much inconvenience in touch operation.

### SUMMARY OF THE INVENTION

The present invention provides an object sensing device including a display panel, a first image sensing unit, a vibration sensing unit, and a control unit. The first image sensing unit is disposed at a periphery of the display panel and has a first sensing area related to the display panel. The vibration sensing unit is disposed at the periphery of the display panel. The control unit is electrically connected to the display panel, the first image sensing unit, and the vibration sensing unit. When the first image sensing unit senses an object in the first sensing area and the vibration sensing unit senses a vibration acted by the object on the display panel, the control unit controls the display panel to execute a predetermined function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an object sensing device according to an embodiment of the present invention.

FIG. 2 is a waveform diagram of a vibration sensing unit sensing a vibration acted by an object on a display panel.

FIG. 3 is a diagram of an object sensing device according to another embodiment of the present invention.

FIG. 4 is a diagram of an object sensing device according to another embodiment of the present invention.

FIG. 5 is a diagram of an object sensing device according to another embodiment of the present invention.

### DETAILED DESCRIPTION

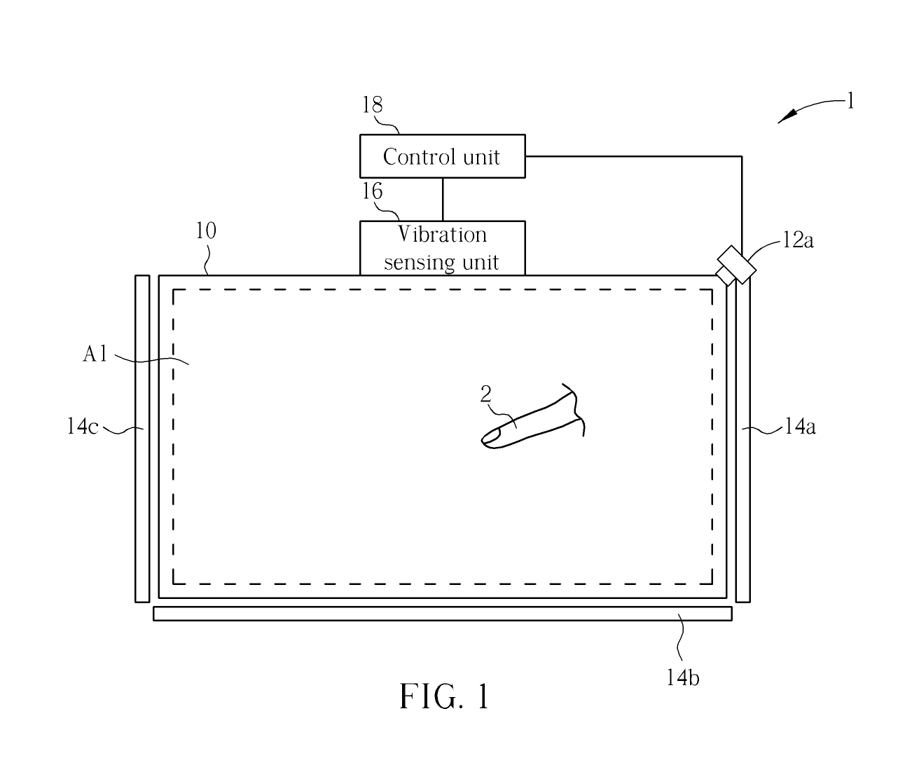

Please refer to FIG. 1, which is a diagram of an object sensing device 1 according to an embodiment of the present invention. As shown in FIG. 1, the object sensing device 1 includes a display panel 10, a first image sensing unit 12a, three light emitting units 14a, 14b, 14c, a vibration sensing unit 16, and a control unit 18. The first image sensing unit 12a is disposed at a periphery of the display panel 10. The first image sensing unit 12a has a first sensing area A1 related to the display panel 10. In this embodiment, the first image sensing unit 12a is disposed at a corner of the display panel 10, so that the first sensing area A1 of the first image sensing unit 12a can cover an efficient display area of the display panel 10. The three light emitting units 14a, 14b, 14c are disposed at the periphery of the display panel 10 for providing the first image sensing unit 12a with light for sensing an object 2. The vibration sensing unit 16 is disposed at the periphery of the display panel 10 for sensing a vibration acted on the display panel 10. Furthermore, in practical application, the display panel 10 can have a protective member (not shown in figures), such as a protective glass, for a user to perform touch operations thereon. At this condition, the vibration sensing unit 16 can be disposed on the protective member instead. To be noted, as long as the vibration sensing unit 16 is disposed at a position where the vibration sensing unit 16 can sense a vibration acted on the display panel 10, disposal of the vibration sensing unit 16 is not limited to this embodiment. The control unit 18 is electrically connected to the display panel 10, the first image sensing unit 12a, the three light emitting units 14a, 14b, 14c, and the vibration sensing unit 16.

In practical application, the first image sensing unit 12a can be a charge-coupled device (CCD), or a complementary metal-oxide semiconductor (CMOS) sensor. The light emitting units 14a, 14b, 14c can be an independent light source (e.g. a light emitting diode (LED)), or an assembly of a light guide bar and a light source. It should be mentioned that number and disposal of the light emitting units is not limited to FIG. 1, meaning that it may vary with the practical application of the object sensing device 1. The control unit 18 can be a controller with a data processing function.

In general, the object sensing device 1 further includes software/hardware needed for operation (e.g. a central processing unit (CPU), a memory, a storage device, a battery for power supply, and an operating system), and related description is omitted herein since it is commonly seen in the prior art.

When operating the object sensing device 1, the control unit 18 controls the light emitting units 14a, 14b, 14c to emit light. When a user utilizes the object 2 (e.g. the user's finger or a stylus) to perform touch operations in the first sensing area A1, the object 2 interrupts partial light emitted from the light emitting units 14a, 14b, 14c. At the same time, the first image sensing unit 12a senses the object 2 in the first sensing area A1. Subsequently, the control unit 18 controls the display panel 10 to execute a predetermined function (i.e. a function corresponding to a touch operation).

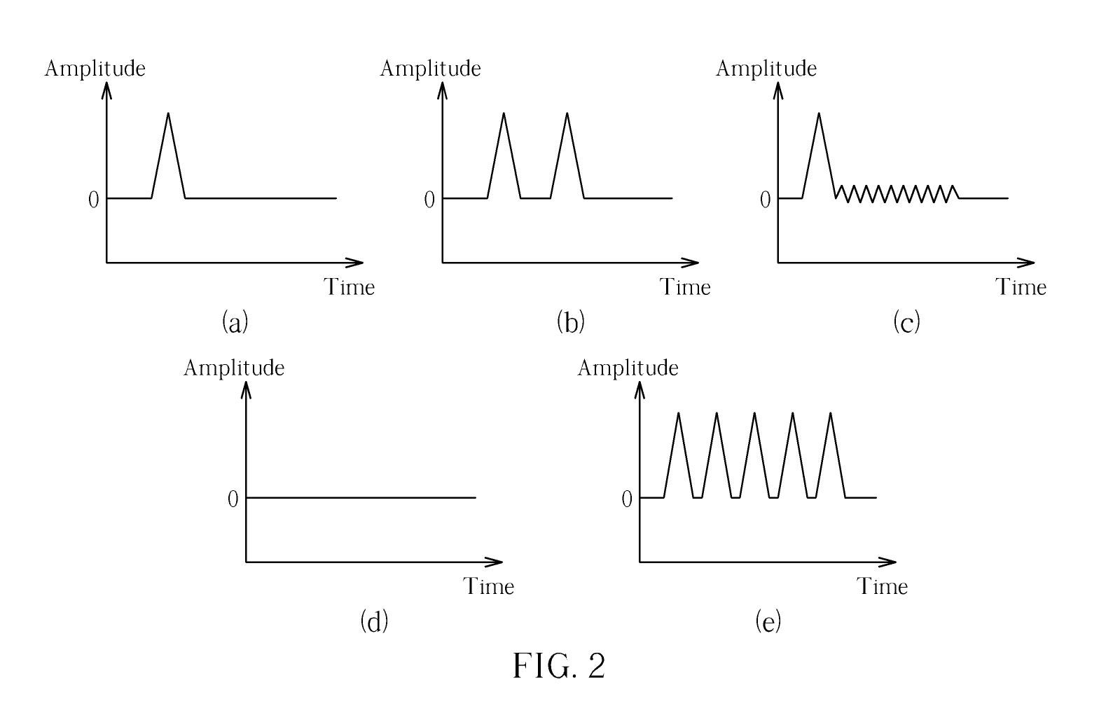

Please refer to FIG. 2, which is a waveform diagram of the vibration sensing unit 16 sensing a vibration acted by the object 2 on the display panel 10. The vibration sensing unit 16 can help the first image sensing unit 12a to determine the function that the user wants to execute. For example, when the user utilizes the object 2 to touch the display panel 10 one time in the first sensing area A1, the first image sensing unit 12a senses the object 2 in the first sensing area A1, and the vibration sensing unit 16 senses one vibration acted by the object 2 on the display panel. As shown in FIG. 2(a), the vibration sensing unit 16 senses a vibration signal with a peak amplitude value. At this time, the control unit 18 controls the display panel 10 to execute the predetermined function, such as a one-click function (e.g. showing the position indicated by the object 2).

Description for how the object sensing device 1 executes a multiple-click function is further provided as follows. For example, when the user utilizes the object 2 to touch the display panel 10 twice in the first sensing area A1, the first image sensing unit 12a senses the object 2 in the first sensing area A1, and the vibration sensing unit 16 senses two vibrations acted by the object 2 on the display panel 10. As shown in FIG. 2(b), the vibration sensing unit 16 senses a vibrations signal with two peak amplitude values. At this time, the control unit 18 controls the display panel 10 to execute the predetermined function, such as a double-click function (e.g. opening a file folder or executing application software). Thus, the object sensing device 1 can help the display panel 10 correctly execute the double-click function that the user wants to execute.

Furthermore, when the user utilizes the object 2 to touch the display panel 10 one time and then perform a drag operation to generate a continuous vibration, as shown in FIG. 2(c), the vibration sensing unit 16 senses a vibration signal with one peak amplitude value following a series of weak amplitude values. At this time, the control unit 18 controls the display panel 10 to execute the predetermined function, such as a drag function (e.g. moving a cursor or dragging a file) or a handwriting function (e.g. allowing the user to input a letter or a symbol by hand).

Furthermore, when the first image sensing unit 12a senses the object 2 in the first sensing area A1 and the vibration sensing unit 16 has not sensed a vibration acted by the object 2 on the display panel 10 yet, the control unit 18 controls the display panel 10 not to be activated. For example, when the user has not decided which function to execute yet and then moves the object 2 forth and back in the first sensing area A1, the first image sensing unit 12a has already sensed the object 2 in the first sensing area A1. However, at this time, the vibration sensing unit 16 has not sensed a vibration acted by the object 2 on the display panel 10 yet, meaning that the vibration sensing unit 16 senses no vibration signal as shown in FIG. 2(d). Thus, the control unit 18 controls the display panel 10 not to be activated, and then waits for the user's next operation.

In another embodiment, when the display panel 10 and the first image sensing unit 12a is in a power-saving mode and the vibration sensing unit 16 senses a vibration acted by the object 2 on the display panel 10, the control unit 18 controls the display panel 10 and the first image sensing unit 12a to be reactivated. For example, after the user does not operate the object sensing device 1 over a period of time, the display panel 10 and the first image sensing unit 12a can be set to enter the power-saving mode by a predetermined program for power saving. When the user wants to reactivate the object sensing device 1, the user can utilize the object 2 to touch the object sensing device 1 a specific number of times (e.g. touching the display panel 10 five times). At this time, the vibration sensing unit 16 senses a vibration signal with five peak amplitude values as shown in FIG. 2(e). Subsequently, the control unit 18 controls the display panel 10 and the first image sensing unit 12a to be reactivated, so as to allow that the user can utilize the object sensing device 1 to perform touch operations again.

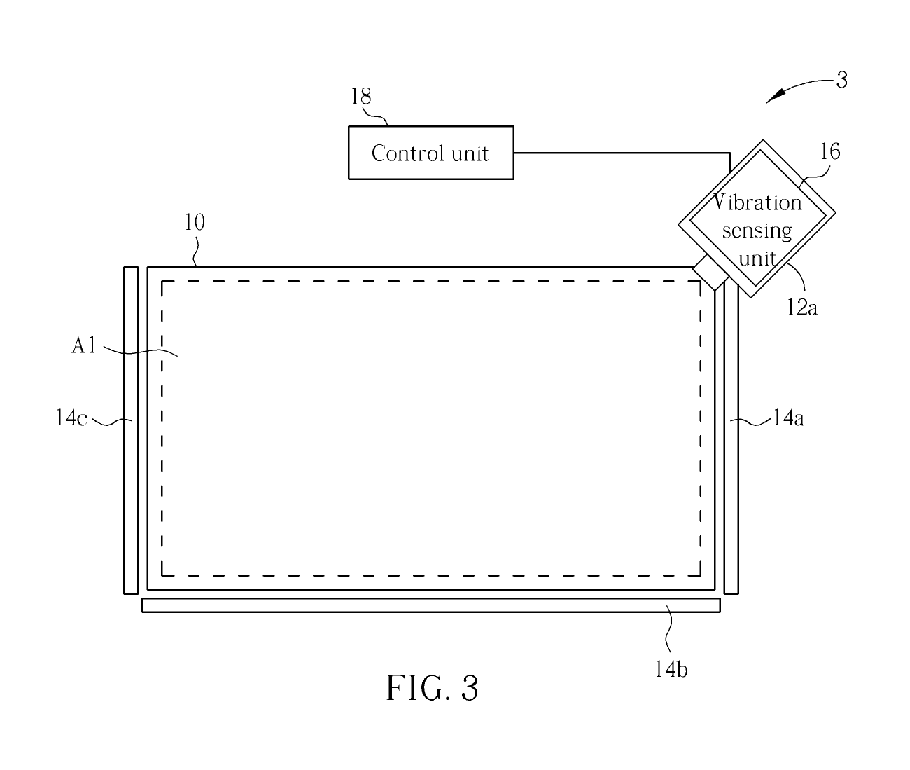

Please refer to FIG. 3, which is a diagram of an object sensing device 3 according to another embodiment of the present invention. As shown in FIG. 1 and FIG. 3, the major difference between the object sensing device 3 and the object sensing device 1 is that the vibration sensing unit 16 of the object sensing device 3 can be integrated into the first image sensing unit 12a. Furthermore, components both mentioned in FIG. 1 and FIG. 3 represent components with similar functions and structures, and related description is therefore omitted herein.

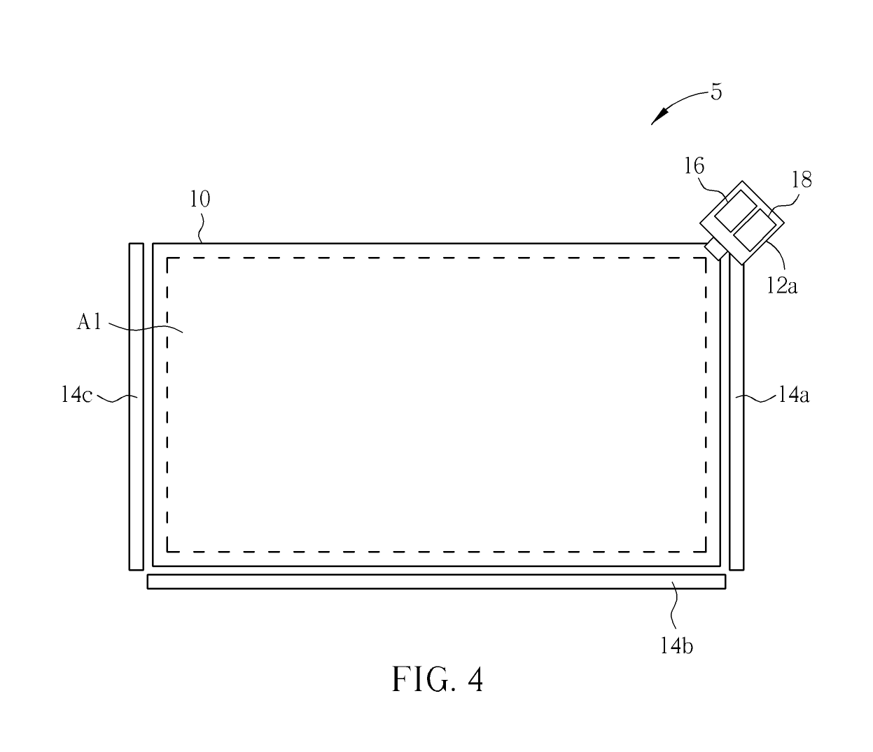

Please refer to FIG. 4, which is a diagram of an object sensing device 5 according to another embodiment of the present invention. As shown in FIG. 1 and FIG. 4, the major difference between the object sensing device 5 and the object sensing device 1 is that the vibration sensing unit 16 and the control unit 18 of the object sensing device 5 can be integrated into the first image sensing unit 12a. Furthermore, components both mentioned in FIG. 1 and FIG. 4 represent components with similar functions and structures, and related description is therefore omitted herein.

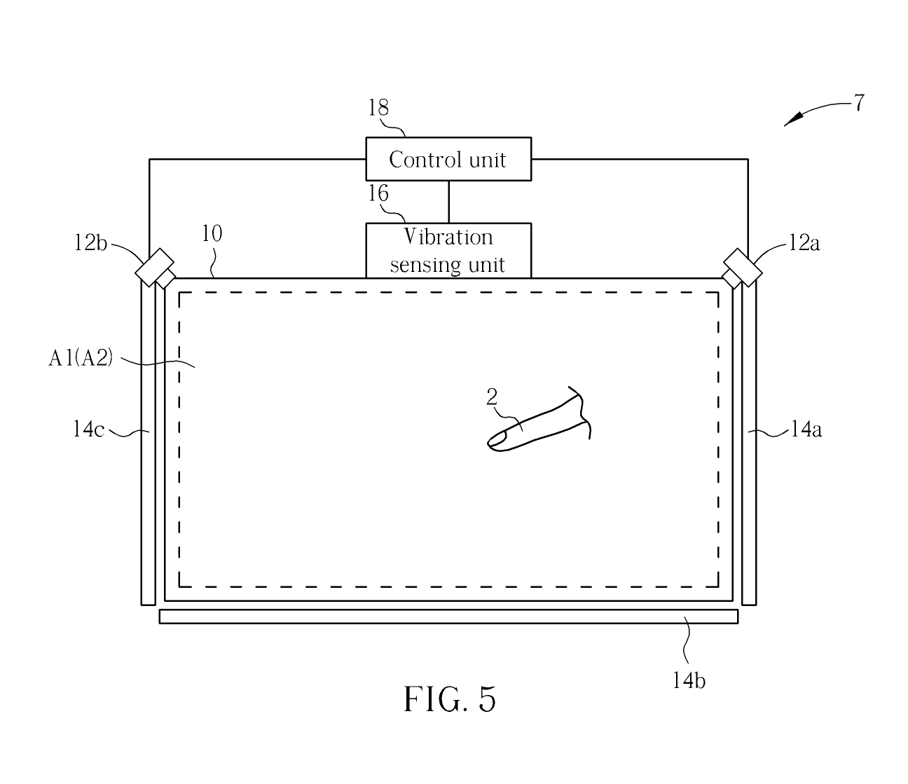

Please refer to FIG. 5, which is a diagram of an object sensing device 7 according to another embodiment of the present invention. As shown in FIG. 1 and FIG. 5, the major difference between the object sensing device 7 and the object sensing device 1 is that the object sensing device 7 further includes a second image sensing unit 12b, which is disposed at the periphery of the display panel 10 and opposite to the first image sensing unit 12a. Furthermore, the second image sensing unit 12b has a second sensing area A2. In this embodiment, the first image sensing unit 12a and the second image sensing unit 12b are disposed at opposite corners of the display panel 10 respectively, so that the first sensing area A1 and the second sensing area A2 can cover the efficient display area of the display panel 10 respectively. In this embodiment, the second sensing area A2 overlaps the first sensing area A1. As shown in FIG. 5, when the first image sensing unit 12a and the second image sensing unit 12b sense the object 2 in the first sensing area A1 and the second sensing area A2 respectively and the vibration sensing unit 16 senses a vibration acted by the object 2 on the display panel 10, the control unit 18 controls the display panel 10 to execute the predetermined function. Since the operating principle of the second image sensing unit 12b is similar to that of the first image sensing unit 12a, related description for the second image sensing unit 12b is therefore omitted herein. Furthermore, components both mentioned in FIG. 1 and FIG. 5 represent components with similar functions and structures, and related description is therefore omitted herein.

In summary, the object sensing device provided by the present invention utilizes the vibration sensing unit to help the image sensing unit precisely determine the function that a user wants to execute. For example, when a user has not decided which function to execute yet, the user may move an object (e.g. the user's finger or a stylus) forth and back in the sensing area. In this condition, although the image sensing unit has already sensed the object in the sensing area, the control unit can still control the display panel not to be activated and then wait for the user's next operation since the vibration sensing unit has not sensed a vibration acted by the object on the display panel yet. Furthermore, even if the user just utilizes the object to lightly touch the display panel twice in the sensing area, the object sensing device can still determine that the user wants to execute a double-click function since the vibration sensing unit has sensed two vibrations acted by the object. In such a manner, misjudgment of the object sensing device in executing touch functions can be further avoided.

Furthermore, after the user does not operate the object sensing device over a period of time, the display panel and the image sensing unit can set to enter the power-saving mode by a predetermined program for power saving. When the user wants to reactivate the object sensing device, the user can utilize the object to touch the object sensing device a specific number of times (e.g. touching the display panel five times), and then the control unit controls the display panel and the image sensing unit to be reactivated, so as to allow that the user can utilize the object sensing device to perform touch operations again. That is to say, the present invention can further provide a user with another way to reactivate the object sensing device.

Those skilled in the art will readily observe that numerous modifications and alterations of the device and method may be made while retaining the teachings of the invention.

What is claimed is:

1. An object sensing device comprising:
a display panel;
a first image sensing unit disposed at a periphery of the display panel and having a first sensing area related to the display panel;
a vibration sensing unit disposed at the periphery of the display panel; and
a control unit electrically connected to the display panel, the first image sensing unit, and the vibration sensing unit;
wherein when the first image sensing unit senses an object in the first sensing area and the vibration sensing unit senses a vibration acted by the object on the display panel, the control unit controls the display panel to execute a predetermined function.

2. The object sensing device of claim 1, wherein when the first image sensing unit senses the object in the first sensing area and the vibration sensing unit has not sensed a vibration acted by the object on the display panel yet, the control unit controls the display panel not to be activated.

3. The object sensing device of claim 1, wherein when the object touches the display panel one time or more to generate one vibration or more, the predetermined function is a one-click function or multiple-click function.

4. The object sensing device of claim 1, wherein when the object performs a one-touch operation and a drag operation on the display panel to generate a continuous vibration, the predetermined function is a drag function or a handwriting function.

5. The object sensing device of claim 1, wherein when the display panel and the first image sensing unit is in a power-saving mode and the vibration sensing unit senses a vibration acted by the object on the display panel, the control unit controls the display panel and the first image sensing unit to be reactivated.

6. The object sensing device of claim 1, wherein the vibration sensing unit is integrated into the first image sensing unit.

7. The object sensing device of claim 1, wherein the control unit is integrated into the first image sensing unit.

8. The object sensing device of claim 1 further comprising:
a second image sensing unit disposed at the periphery of the display panel and opposite to the first image sensing unit;
wherein the second image sensing unit is electrically connected to the control unit and has a second sensing area related to the display panel, and the control unit controls the display panel to execute the predetermined function when the first image sensing unit and the second image sensing unit sense the object in the first sensing area and the second sensing area respectively and the vibration sensing unit senses a vibration acted by the object on the display panel.

9. The object sensing device of claim 1 further comprising:
a light emitting unit disposed at the periphery of the display panel for providing the first image sensing unit with light to sense the object.

10. The object sensing device of claim 1, wherein the display panel has a protective member, and the vibration sensing unit is disposed on the protective member.
